(19) United States
(12) Patent Application Publication
(10) Pub. No.: US 2006/0229891 A1
(43) Pub. Date: Oct. 12, 2006

(54) Drive-up dispensing device for car wash facility

(75) Inventor: Richard M. Grier, Ankeny, IA (US)

Correspondence Address: ZARLEY LAW FIRM P.L.C., CAPITAL SQUARE, 400 LOCUST, SUITE 200, DES MOINES, IA, 50309-2350, US

(73) Assignee: RYKO MANUFACTURING COMPANY, Grimes, IA (US)

(21) Appl. No.: 11/100,274

(22) Filed: Apr. 6, 2005

(51) Int. Cl. G06Q 99/00

(52) U.S. Cl. 705/1

(57) ABSTRACT

A drive-up product dispensing system for a car wash facility having a pay station that is connected to a car wash assembly and a dispensing device is connected to the pay station.

### BACKGROUND OF THE INVENTION

This invention is directed toward a product dispensing device for a car wash facility and more particularly to a drive-up dispensing device connected to a car wash assembly.

Car wash devices are well-known in the art and come in a variety of shapes and sizes. Some of these car wash devices are connected to an automated drive-up pay station that allows users to select and pay for the wash, or enter a code to activate the car wash without leaving their car or requiring assistance from a sales clerk or operator.

Vending machines are also known in the art and are used at car wash facilities to provide a variety of wash related products. These vending machines are typically centrally located at the car wash facility and are either built into the wall of the facility or are a stand alone unit. As a result, however, a customer must leave their vehicle to use the vending machine and acquire a desired product. Not only is this inconvenient and time consuming for a customer, but it requires a customer to incur multiple transactions to pay for the wash, as well as the car wash product. Further, because of the inconvenience of leaving the vehicle, fewer products may be sold by the car wash owner as customers are less likely to buy. Also, the car wash owner misses out on the opportunity to market, sell, and provide products to a car wash user while they wait in line for their car wash. Accordingly, there is a need in the art for a dispensing system that eliminates these problems in the art.

Therefore, a principal objective of the present invention is to provide a dispensing device that is more convenient to use for a customer.

A further objective of the present invention is to provide a dispensing device for a car wash facility where a customer can purchase products without leaving their vehicle.

A still further objective of the present invention is to provide a dispensing device where a customer can purchase a car wash and car wash products through a single transaction.

An additional object is to provide a dispensing system that increases car wash sales and/or product sales to car wash customers while waiting in line for a car wash.

These and other objectives will be apparent to those skilled in the art based on the following description.

### SUMMARY OF THE INVENTION

A drive-up product dispensing system for a car wash facility having a pay station that is connected to a car wash assembly and a dispensing device connected to the pay station.

### BRIEF DESCRIPTION OF THE DRAWINGS

FIG. 1 is a perspective view of a drive-up product dispensing system for a car wash facility;

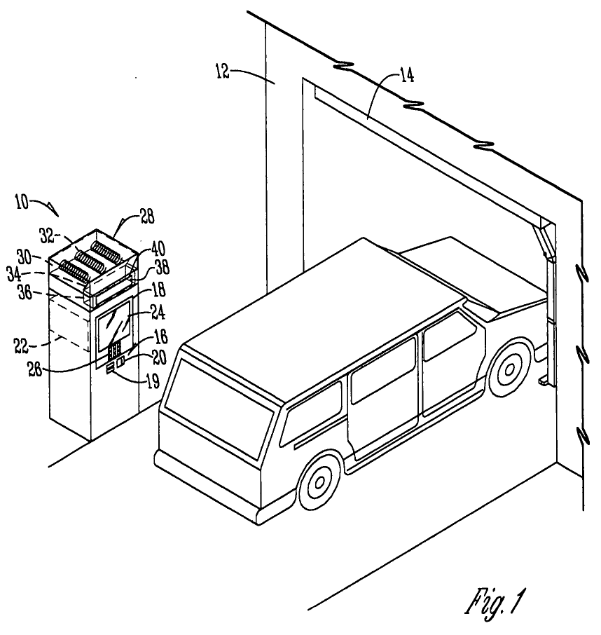

FIG. 2 is a side view of a drive-up product dispensing system for a car wash facility; and

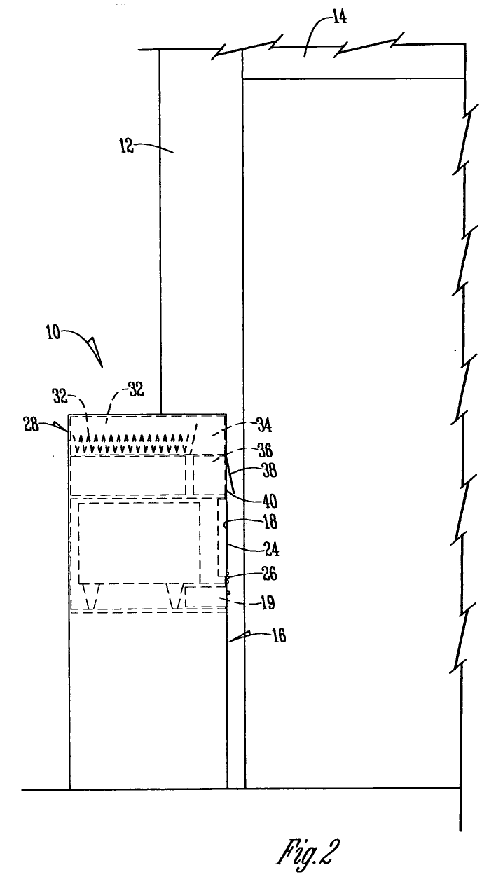

FIG. 3 is a top view of a drive-up product dispensing system for a car wash facility.

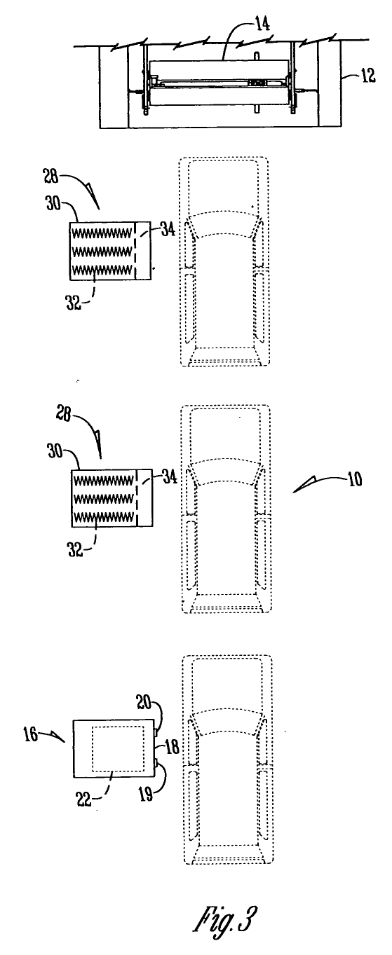

### DETAILED DESCRIPTION OF THE PREFERRED EMBODIMENT

Referring to the figures the drive-up product dispensing system 10 is used with a car wash facility 12 having a car wash assembly 14. The system 10 has a pay station 16 located near the entry of the car wash assembly 14. While any type of pay station could be used, preferred is a pay station having a selection device such as a touch screen 18, a cash acceptor 19, and a card reader 20. The pay station 16 has a controller 22 that is electrically or wirelessly connected to the car wash assembly 14, and a remote credit card authorization system that recognizes credit card numbers and authorizes payment that is accessed either by a phone connection or through a website on the Internet.

The touch screen 18 has a video display 24 where various types of car washes and products may be promoted. The car washes and products may also be promoted via an audio transmission used in conjunction with the touch screen 18 or separately. The touch screen 18 allows a customer to enter an entry code for a pre-paid car wash and/or product and allows the customer to make various car wash and product selections. Alternatively, the selection device is an input device 26 such as a key pad, a scanner that reads a radio frequency identification device, voice activation system, fingerprint scanner or any other authorization/identification system. The video display 24 and the touch screen 18, as well as the cash acceptor 19 and card reader 20 are all connected to and operated by the controller 22. The selection of different types of car washes and products can occur in a number of ways. For example, a customer may separately select both a car wash type and a product selection at the pay station 16 or from a remote location. Alternatively, the car wash owner may selectively program the controller 22 to provide a specific product to be dispensed based on the car wash type selected. This allows a car wash owner to encourage car wash customers to purchase more expensive car wash packages. In addition, the controller 22 may be programmed to distribute a product with any car wash selection to enable a car wash owner to distinguish his facility from those of competitors. Also, the system may be programmed to dispense a product with no selection of a car wash or product being made. This further allows a car wash owner to distinguish his or her car wash from the competition when only a single type of car wash is available.

Mounted to or connected to the pay station 16, is a dispensing device 28. The dispensing device 28 has a storage area 30 that contains at least one or a plurality of products. Preferably, the dispensing device 28 contains products such as drying towels, tire cleaner, a damp cloth, air freshener, candy bars, toys and the like. While product may be stored and dispensed in a number of ways, preferred is a rotatable helical coil 32 which moves product forward within the coil 32 until the product falls into a dispensing chute 34 that leads to a dispensing area 36. Preferably, the dispensing area 36 is positioned at a height that can be accessed easily by a customer sitting in their vehicle and optionally has a hinged cover 38 positioned over an opening 40 to the dispensing area 36.

Alternatively, one or more dispensing devices 28 are connected to the pay station 16. For example, several dispensing devices 28 could be positioned past the pay station 16 such that customers could receive product while they are waiting in line to enter the car wash assembly 14. Also, one or more dispensing devices 28, connected to the pay station 16, may be positioned at the exit of the wash assembly 14. Each dispensing device might have a selection device such as a touch screen 18 or an input device 26 that allows the customer to enter an access code.

In operation, a customer drives alongside the pay station 16 such that the customer may access the pay station from their vehicle. The pay station 16, via the controller 22 through the video display 24 or other similar means prompts the customer to select the type of car wash desired or enter a code if the customer has prepaid. To select a particular type of car wash, the customer enters the selection by engaging the touch screen 18 or the input device 26. The video display 24 also may prompt the customer to make product selections. The system may also be set for a product selection only where a car wash only has one type of wash or the owner wishes to limit the type of wash offered. In response, the customer either enters a selection, or indicates that no selection will be made, by engaging the touch screen 18 or the input device 26. Once all selections have been made the controller 22, through the video display 24, prompts the customer to make payment either by inserting the requested amount in the cash acceptor 19 or inserting a credit or debit card in the card reader 20. Once the required amount has been inserted in the cash acceptor 19, or the payment card has been authorized and charged via the phone connection or remote website, the controller 22 will activate the dispensing device 28 to deliver the selected product. In one example, the controller 22 rotates the helical coil 32 such that the selected product is moved forward to a position where the product falls into and through the dispensing chute 34 to the dispensing area 36 where the customer is able to remove the product from the dispensing area 36 without leaving the vehicle. Then the controller 22, through the video display 24, instructs the customer to drive forward and enter the car wash assembly 14.

As an alternative, where a customer purchases the wash and/or selected products at a remote location, the customer enters an authorization code through the touch screen 18 or the input device 26, whereby the controller 22 activates the dispensing device 28 to deliver the purchased products to the dispensing area 36. Also, where the system is programmed to deliver a product based on the type of wash selected, the customer is prompted by the video display to make a car wash type selection by engaging the selection device such as the touch screen 18. Once the desired car wash type has been selected and payment has been received or authorized, the controller 22 activates the dispensing device 28 to deliver a generic product, or deliver a product based on the type of car wash selected. Finally, where the system is programmed to deliver a product based on payment alone, once payment has been received or authorized the controller 22 activates the dispensing device to deliver a product.

Accordingly, the drive-up product dispensing system described meets all the stated objectives.

I claim:

1. A drive-up dispensing system for a car wash facility, comprising:
a pay station connected to a car wash assembly, and
a dispensing device connected to the pay station and containing at least one product.

2. The system of claim 1 wherein a product is delivered automatically upon payment for a car wash.

3. The system of claim 1 wherein the pay station has a selection device capable of selecting a desired type of car wash.

4. The system of claim 3 wherein the dispensing device delivers a product based upon the desired type of car wash selected.

5. The system of claim 3 wherein the dispensing device delivers a product upon selection of the type of car wash.

6. The system of claim 1 wherein the pay station has a selection device capable of selecting at least one of the products contained in the dispensing device.

7. The system of claim 6 wherein the selection device is capable of selecting a desired type of car wash.

8. The system of claim 1 having a controller connected to the pay station, the dispensing device, and the car wash assembly.

9. The system of claim 1 wherein the dispensing device has a product storage area in communication with a delivery chute that terminates in a delivery area.

10. The system of claim 1 wherein the dispensing area has an opening and a cover connected to the dispensing device that covers the opening.

11. The system of claim 3 wherein the selection device is a touch screen.

12. The system of claim 1 wherein the pay station has a cash acceptor and a card reader.

13. The system of claim 1 wherein a plurality of dispensing devices are connected to the pay station.

14. The system of claim 1 wherein the dispensing device is mounted to the pay station.
